(19) United States
(12) Patent Application Publication
(10) Pub. No.: US 2007/0107227 A1
(43) Pub. Date: May 17, 2007

(54) Method for manufacturing catalyzed diesel particulate filter

(76) Inventor: Choong Il Kwon, Uijeongbu-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/497,933

(22) Filed: Aug. 1, 2006

(30) Foreign Application Priority Data
Nov. 10, 2005 (KR) 10-2005-0107333

(51) Int. Cl. B23P 15/16

(52) U.S. Cl. 29/896.62

(57) ABSTRACT

A method of manufacturing a diesel catalyzed particulate filter includes the steps of (a) preparing a plurality of segments, (b) coating each segment or group of segments with a different type or concentration of a catalyst solution, and drying the segments, and (c) binding the segments together, and sintering the segments.

### CROSS-REFERENCE TO RELATED APPLICATIONS

This application claims benefit under 35 U.S.C. § 119(a) of Korean Patent Application No. 10-2005-0107333, filed Nov. 10, 2005, the entire contents of which are incorporated herein by reference.

### BACKGROUND OF THE INVENTION

1. Field of the invention

The present invention relates to a method of manufacturing a diesel catalyzed particulate filter. More particularly, the present invention relates to a method of manufacturing a diesel catalyzed particulate filter in which kind and/or concentration of catalysts vary across a cross-section of the filter.

2. Description of the Related Art

Generally, exhaust gas is discharged to air through an exhaust pipe. The exhaust gas includes carbon monoxide (CO), nitrogen oxide (NOx), non-combusted hydrocarbon (HC), and other toxic substances. Diesel engines emit exhaust gas containing relatively small amounts of carbon monoxide (CO) and hydrocarbon (HC) compared to gasoline engines, but relatively high amounts of particulate matter and nitrogen oxides.

A catalytic converter using a three-way catalyst is generally installed in the middle of an exhaust pipe to purify exhaust gas. Catalysts used in catalytic converters can differ because emissions vary with vehicle type. A three-way catalyst, which is generally a combination of platinum (Pt) and rhodium (Rh), a combination of palladium (Pd) and rhodium (Rh), or a combination of platinum (Pt), palladium (Pd) and rhodium (Rh), reacts with hydrocarbons, carbon monoxide, and nitrogen oxide.

There are many conventional coating methods for coating different concentrations of catalyst on a ceramic support. For example, one method is a dipping method, in which a ceramic support is sequentially dipped in catalyst solutions with different concentrations. Another method is a suction method in which one end of a support is first dipped into a catalyst solution, and the catalyst solution is suctioned through the support by applying a negative pressure to the other end of the support. This can be repeated on the other side of the support with a different concentration of catalyst solution.

The suction method cannot be used in a diesel particulate filter, which has walled cells to trap soot. However, the dipping method has a disadvantage in that the interior of the support does not have as high a concentration of catalyst as the edges. Flux and temperature of exhaust gas vary over a cross section of the filter. It would therefore be beneficial to provide a catalyzed diesel particulate filter whose catalyst concentration varies accordingly.

### SUMMARY OF THE INVENTION

Embodiments of the present invention provide a method of manufacturing a diesel catalyzed particulate filter comprising the steps of preparing a plurality of segments, the shape and size of each segment being determined according to distribution of flux and temperature of exhaust gas generated during operation of an engine, coating the segments with different types or different concentrations of catalyst solutions by sequentially dipping the segments into catalyst solutions and drying the segments, binding the coated segments together to be a single full-size filter, and sintering the bound segments. The diesel catalyst particulate filter has a cross section on which optimized types and concentrations of catalyst are coated according to flux and temperature of exhaust gas at each position.

### BRIEF DESCRIPTION OF THE DRAWING FIGURES

The above aspect and other features of the present invention will become more apparent by describing in detail exemplary embodiments thereof with reference to the attached drawing figures, wherein;

FIG. 1 is a view illustrating a sequence of manufacturing a catalyzed diesel particulate filter according to embodiments of the present invention;

FIG. 2 is a conceptual view illustrating a cell structure of a segment of a catalyzed diesel particulate filter according to embodiments of the present invention; and

FIG. 3 is a graph illustrating a comparison of purification efficiencies of diesel catalyzed particulate filters according to conventional arts and the present invention.

### DETAILED DESCRIPTION OF THE EXEMPLARY EMBODIMENTS

Hereinafter, embodiments of the present invention will be described in detail with reference to the accompanying drawing figures.

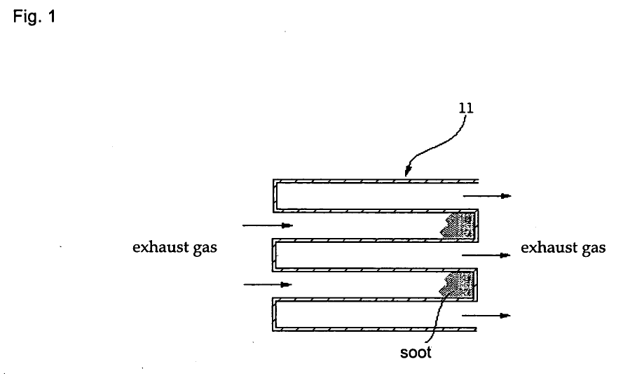

As shown in FIG. 1, a plurality of segments 11 is prepared. The segments 11 combine to make a full-size filter 10 when they are assembled. In some embodiments, around 16 to 20 segments are used; however, their number, shapes, and sizes may vary, as shape and size of the filter 10 depend on automobile type.

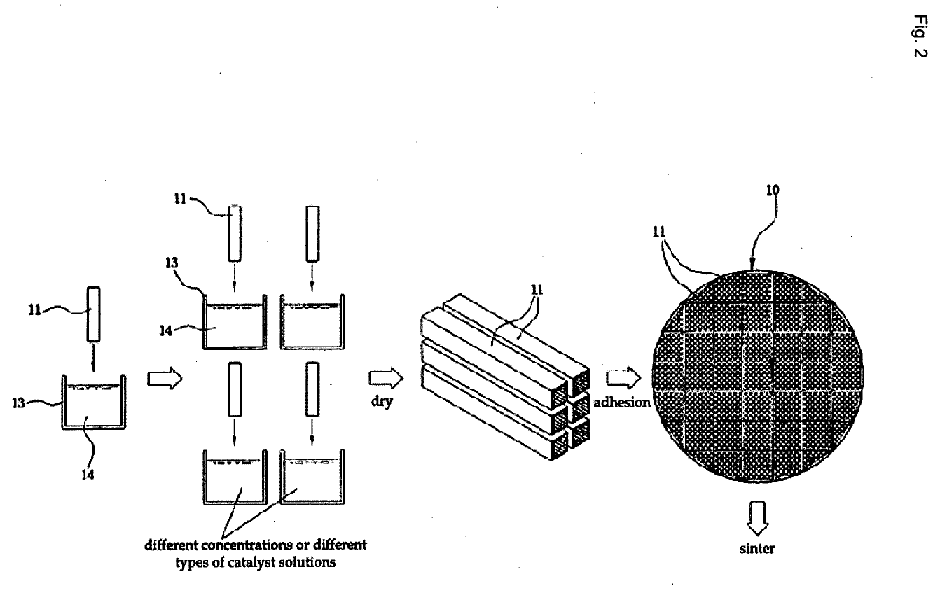

The segments are manufactured using well-known methods. Each segment may have the structure shown in FIG. 2.

A number of vessels 13, the number corresponding to the number of different kinds and/or concentrations of catalysts, are filled with catalyst solutions 14. Each segment 11 is dipped into a corresponding vessel 13 and then taken out. That is, the segments 11 are coated one by one. When coating each segment 11, the concentration and type of catalyst is selected considering flux and temperature of exhaust gas at the segment's assigned location in the cross-section of the filter.

All of the segments can be coated with different catalyst solutions or some of the segments can be coated with the same catalyst solution. For example, if one filter includes 16 segments, the segments can be coated with 16 types of catalysts. Alternatively, the segments can be separated into groups of two or four segments, and then the segments in each group can be coated with the same kind of catalyst.

After finishing the coating process, the segments 11 are dried at about 150° C.

Then, the dried segments are assembled according to their assigned positions and bound together using an adhesive such as silicon carbonate or silica, thereby producing a full-size filter 10.

Next, finally, the segment assembly is sintered below about 600° C., and preferably at about 500 to 550° C.

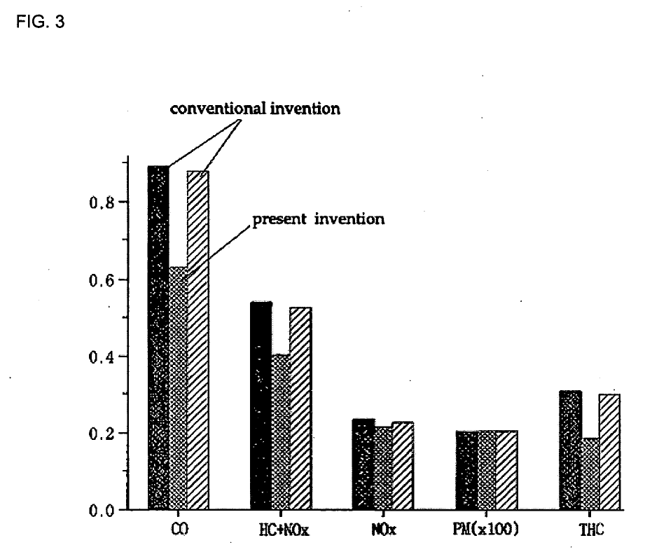

FIG. 3 illustrates a comparison of purification efficiencies in a diesel engine of two conventional catalyzed diesel particulate filters and the present invention catalyzed diesel particulate filter in which a cross section of the filter is coated with different types or concentrations of catalysts. In this figure, the amounts of carbon monoxide (CO), hydrocarbon+nitrogen oxide (HC+NOₓ), nitrogen oxide (NOₓ), particulate matter (PM), and total hydrocarbon (THC) are compared in g/kg.

The leftmost conventional catalyzed diesel particulate filter of FIG. 3 is manufactured by coating a support with 1.06 g/l of platinum at uniform concentration. The rightmost conventional catalyzed diesel particulate filter is manufactured by coating a support with a mixture of platinum and palladium at a platinum/palladium ratio of 2:1 and 1.06 g/l of platinum. The present invention catalyzed diesel particulate filter is manufactured by coating each of four segments disposed in a center portion of the filter with 1.5 g/l of platinum and coating each of the other segments with 0.82 g/l.

While the invention has been shown and described with reference to certain embodiments thereof, it will be understood by those skilled in the art that various changes in form and details may be made therein without departing from the spirit and scope of the invention as defined by the appended claims.

What is claimed is:

1. A method for manufacturing a diesel catalyzed particulate filter, comprising:
(a) preparing a plurality of segments;
(b) coating at least a first one of said segments with a first catalyst solution, coating at least a second one of said segments with a second catalyst solution, and drying the segments; and
(c) binding the segments together and sintering the segments.

2. The method as claimed in claim 1, wherein the coating comprises dipping.

3. The method as claimed in claim 1, wherein the first catalyst solution comprises a first type of catalyst and the second catalyst solution comprises a second type of catalyst.

4. The method as claimed in claim 1, wherein the first catalyst solution comprises a first concentration of a catalyst and the second catalyst solution comprises a second concentration of the catalyst.
